(19) United States
(12) Patent Application Publication
(10) Pub. No.: US 2025/0259759 A1
(43) Pub. Date: Aug. 14, 2025

(54) METHOD AND SYSTEM FOR MEASURING THE POSITION OF A TRANSLATIONALLY MOVABLE ELEMENT OF A NUCLEAR REACTOR

(71) Applicant: SOCIETE TECHNIQUE POUR L'ENERGIE ATOMIQUE, VILLIERS-LE-BÂCLE (FR)

(72) Inventors: Carl ZINONI, LES MILLES (FR); François DONNIER, PERTUIS (FR); Michel BRUN, SIMIANE-COLLONGUE (FR)

(21) Appl. No.: 18/440,513

(22) Filed: Feb. 13, 2024

(51) Int. Cl. G21C 17/02; G01D 5/353

(52) U.S. Cl. CPC G21C 17/021; G01D 5/3537

(57) ABSTRACT

A method for measuring position of a translational movable element of a nuclear reactor, includes emitting kN optical signals, k and N being natural numbers greater than or equal to 1, by kN so-called emitter optical fibres included in N probes resistant to a primary medium; receiving the kN optical signals by N tracks resistant to a primary medium, each track receiving k optical signals, the tracks having reflecting surfaces and diffusing surfaces; receiving, by mN so-called receiver optical fibres, m being a natural number greater than or equal to k, included in the N probes, the kN optical signals reflected or diffused by the N tracks; converting the kN optical signals received by the mN receiver optical fibres into binary code.

### TECHNICAL FIELD OF THE INVENTION

The technical field of the invention is that of measurements classified in terms of safety in a nuclear reactor, in particular but not exclusively a pressurised water reactor.

The present invention relates to position measurement systems and in particular to the measurement of position of a translationally movable element in the nuclear reactor. A typical case is the position measurement of nuclear reaction control absorbers.

### TECHNOLOGICAL BACKGROUND OF THE INVENTION

Several measurement methods make it possible to obtain position of movable elements in a nuclear reactor, such as the movable control rods within a reactor vessel, for example. These measurements are said to be classified in terms of safety, as they form part of the protection of a facility capable of causing environmental pollution, inconveniencing or having a significant impact on the neighbourhood and public, adversely affecting safety in relation to the public, the neighbourhood or the staff of the establishments, or adversely affecting the health and safety of employees at work. In view of their characteristics, nuclear facilities are classified facilities.

Among the methods for measuring positions of movable control rods, there are especially induction measurement technologies and reed relay measurements.

The principle of induction measurement of position consists in passing a magnetic or ferromagnetic target integral with the movable part past coilings, the number of coils being equal to the number of measurement steps. When a control rod is moving relative to at least one detection coil, an output signal is induced. The output signal comprises identifiable characteristics representative of one or more positions of the control rod inside the detection coil and is then processed by a unit to derive these positions. This measurement method has several drawbacks: coils resistant to the temperature and pressure conditions encountered in the reactor are difficult to make, and this measurement principle requires a lot of wiring to be taken out of the vessel. Finally, magnetic and ferromagnetic targets lose their effectiveness when subjected to the temperature conditions of a nuclear reactor vessel.

The principle of reed relay measurement consists in placing a series of reed switches spaced along the length of the control rod stroke and connected to provide output signals. As the control rod moves, a permanent magnet mounted to the control rod applies an external magnetic field to the reed switch assemblies, which turn resistors on or off depending on the position of the magnet. This makes it possible to reduce the number of wires used compared with the previous method, but has a number of drawbacks such as the limited effectiveness of permanent magnets and reed relays under the temperature conditions of a primary medium. Indeed for reed relays, operation is guaranteed at rated voltage up to an ambient temperature of 65° C. to 200° C., according to the model, whereas in a primary medium the temperature varies between 290° C. and 350° C. In addition, the service life of REED relays is greatly reduced in high-temperature media. Finally, the AMDEC (Analyse des modes de défaillance, de leurs effets et de leur criticité-analysis of failure modes, their effects and their criticality) service safety tool is not very favourable to fault detection using this measurement principle. Other technologies for measuring position of a control rod have been studied, for example acoustic position sensors, but these have not been developed on an industrial scale due to the difficulties of qualifying them in a primary medium.

There are now optical fibre position sensors which are being developed in various environments, especially the industrial environment. A method for measuring position of a movable element using optical fibre sensors consists in placing one or more emitter fibres and one or more receiver fibres on a same piece. The emitter fibre or fibres send optical signals to a movable piece, which contains reflecting and diffusing or absorbing surfaces. The reflected or diffused/absorbed signals received are binary coded: a reflected signal will be coded as “1” and a diffused signal will be coded as “0”. Optical fibre position sensors known in the state of the art make it possible to measure absolute or relative positions of a translationally moved piece.

Optical fibre sensors have interesting characteristics: because of the low overall size of fibres, they can be integrated into narrow and difficult to access places. In addition, optical fibre technologies have been developed that are adapted to irradiation, allowing them to be used in a radiative environment without darkening. However, despite their advantages, optical fibre technologies are not adapted to the corrosion and pressure conditions within a nuclear reactor vessel. Initially, therefore, there is a need to know precisely the position of a movable rod of a control rod bundle with a system that is simpler to implement, of low overall size, adapted to the environment of a nuclear reactor vessel and reliable in terms of fault detection. The need lies especially in adapting position sensors of interest in the industrial field, such as optical fibre sensors, to the nuclear field.

### SUMMARY OF THE INVENTION

In this context, the aim of the present invention is to provide one alternative to the previous methods, making it possible to dispense with the aforementioned problems by adapting to the environment of a primary circuit in a nuclear reactor.

For this, a first aspect of the invention relates to a method for measuring position of a translationally movable element in a nuclear reactor, characterised in that it comprises the following steps of:
Emitting kN optical signals, k and N being natural numbers greater than or equal to 1, by kN so-called emitter optical fibres included in N probes resistant to a primary medium;
Receiving the kN optical signals by N tracks resistant to a primary medium, each track receiving k optical signals, said tracks consisting of reflecting surfaces and diffusing surfaces;
Receiving, by mN so-called receiver optical fibres, m being a natural number greater than or equal to k, included in the N probes, the kN optical signals reflected or diffused by the N tracks;
Converting the kN optical signals received by the mN receiver optical fibres into binary code.

The invention implements an optical fibre position sensor for measuring, for example, an absolute position of a movable element in the reactor. Said sensor is simpler to set up than the other methods discussed: there are no fine coiling wires to manufacture, for example. Furthermore, unlike a conventional optical fibre measurement method used in an industrial environment, for example, the invention implements a system comprising optical fibre probes and tracks adapted to the conditions and stresses of a primary medium in a nuclear reactor vessel. By primary medium, in a primary circuit of a nuclear reactor, it is meant a medium whose heat transfer fluid is subject to the following parameters:
Particularly corrosive high-temperature pressurised water medium
Pressure between 120 bar and 180 bar
Temperature between 250° C. and 350° C.
Water flow rate between 2 m/s and 5 m/s
Irradiation (gamma and neutrons) between 2 MGy and 100 MGy

Thus, the optical fibres are included in protective probes resistant to a primary medium and are not directly exposed to high temperature and pressure water.

According to one embodiment, the above-mentioned method makes it possible to obtain measurement of position of the translationally movable element with a measurement accuracy which depends on N and is equal to the length of the tracks divided by 2 N. This embodiment allows the desired accuracy to be selected by choosing the number N.

In another embodiment of the method, the translationally movable element rotationally drives a cylindrical component, said rotational cylindrical component being surrounded by an auxiliary track consisting of P reflecting surfaces and P diffusing surfaces, P being greater than or equal to 1, said auxiliary track being resistant to a primary medium, the method being characterised in that it comprises the following additional steps for measuring relative position of the translationally movable element:
Emitting two optical signals, by two so-called emitter optical fibres included in two auxiliary probes resistant to a primary medium, the auxiliary probes being spaced apart by a non-zero angle;
Receiving the two optical signals by the track;
Receiving, by at least two so-called receiver optical fibres, included in the two auxiliary probes, the two optical signals reflected or diffused by the auxiliary track;
Transmitting and interpreting the two optical signals received by the receiver optical fibres by a processing unit.

Advantageously, the invention implements a second relative measurement of position of a translationally movable element, in addition to the first one previously mentioned, thus making it possible to have two position measurements and to improve measurement accuracy, with devices that are resistant to a primary medium. According to the alternative embodiment, the accuracy in measuring relative position of a translationally movable element in a nuclear reactor depends on the total number of reflecting surfaces and diffusing surfaces and is equal to 2 P.

Further to the characteristics just discussed in the previous paragraph, a characteristic of the measurement method may be, for one of the N probes and the two auxiliary probes, comprising an emitter optical fibre and at least one receiver optical fibre:
the reflected or diffused nature of an optical signal received by the at least one receiver optical fibre is determined by means of the intensity of the optical signal received by the at least one receiver optical fibre according to the following steps:
   When the intensity of the optical signal received is greater than or equal to a high threshold, the optical signal received by the at least one receiver optical fibre of said probe is a so-called reflected optical signal;
   When the intensity of the optical signal received is greater than or equal to a low threshold and is strictly lower than the high threshold, the low threshold being strictly lower than the high threshold, the optical signal received by the at least one receiver optical fibre of the probe is a so-called diffused optical signal;
      and the difference between the intensity of the optical signal reflected and the intensity of the optical signal diffused is equal to 13 dB, and the high threshold is such that the difference between the intensity of the reflected signal and the high threshold is between 0 dB and 13 dB.

The invention makes it easy to detect a reflected or diffused optical signal by means of the high and low thresholds previously defined.

Furthermore, of the N probes and the two auxiliary probes, comprising an emitter fibre and at least one receiver fibre:
When the intensity of the optical signal received by the receiver optical fibre is zero or positive and lower than the low threshold, the optical signal received by the at least one optical fibre is said to be defective.
   The difference between the intensity of the reflected optical signal and the low threshold is equal to 28 dB and the difference between the high threshold and the low threshold is preferably greater than or equal to 15 dB.

Advantageously, the invention has a three-level coding instead of a binary coding, allowing the detection of defective signals in addition to the reflected or diffused signals, in order to detect possible anomalies or faults and to guarantee a required level of security.

Another aspect of the invention relates to an optical fibre probe for measuring position of a movable element able to measure position of a movable element in a nuclear reactor according to the method, including:
an emitter optical fibre and a receiver optical fibre;
an envelope for protecting the optical fibres, including:
   at least one sealed flexible part comprising a metal that is resistant to a primary medium; this flexible part providing both flexibility for conveying the probe in the internal arrangement of the reactor, and to accommodate difference in expansion between the fibre and the metal envelope,
   at least one sealed rigid part comprising a metal or ceramic resistant to a primary medium;
   a sealed transparent window resistant to a primary medium, soldered to the end of the rigid metal part.

The envelope comprises materials resistant to a primary medium, to corrosion and to oxidation and can therefore be immersed in a primary circuit without the optical fibres being damaged. The transparent window allows optical signals to pass therethrough.

According to one embodiment, a characteristic of the optical fibre probe is:
a first end of the rigid part is welded to a first end of the flexible part;
a second end of the rigid part is welded to the transparent window.

This advantageous embodiment enables sealing of the ends of the rigid part in the primary medium to be ensured.

According to one alternative embodiment, the envelope of the optical fibre probe comprises a mirror tilted by 45° with respect to the axis of the rigid part of the probe. Indeed, it is possible that the fibres used within the probe have a small angle of curvature and that their radial edges cannot be placed facing the reflecting or diffusing tracks, wherein the optical signals can then be reflected by a mirror, thus enabling the fibres to be placed parallel to the movement of the movable element and reducing the overall size.

According to one advantageous embodiment, the optical fibres included in the probe are made of materials resistant to irradiations at some wavelengths, for example between 800 nm and 1000 nm for multimode optical fibres and between 1000 nm and 1150 nm for single-mode optical fibres. Thus blackening of optical fibres is greatly reduced at said wavelengths under the effect of radiation in a nuclear reactor.

Another aspect of the invention relates to a system for measuring position of a movable element in a nuclear reactor comprising:
N optical fibre probes;
N tracks consisting of diffusing surfaces and reflecting surfaces resistant to a primary medium;
   able to implement the method according to the invention

The system makes it possible to measure position of any movable element, in general and more precisely a control rod in a nuclear reactor vessel. The tracks can be made of resistant metals and coatings adapted to a primary medium, which avoids their blackening.

According to a first embodiment of the system previously mentioned, a first track among the N tracks comprises a diffusing surface, a second track among the N tracks comprises a reflecting surface, and a diffusing surface and any additional track comprises twice the number of reflecting tracks and diffusing tracks with respect to the previous track.

Each additional track makes it possible to improve the position measurement accuracy.

According to one embodiment, the previously mentioned system includes a mechanical system comprising:
A roller cooperating with the movable tracks and integral with a hinged arm;
A spring cooperating on the one hand with the hinged arm and on the other hand with a fixed support;
and characterised in that one of the N probes is attached to the hinged arm.

Optical signals are sensitive to the distance travelled because they travel several interfaces having several different indices, and indices vary with temperature. Thus, the distance between a transparent window and the tracks should be as small as possible and, above all, constant. The aforementioned mechanical system makes it possible to keep this distance constant in the event of mechanical vibrations and play within a reactor.

According to one embodiment, the measurement system comprises:
An auxiliary track consisting of P reflecting surfaces and P diffusing surfaces;
Two optical fibre probes spaced apart by a non-zero angle.

Advantageously, the system comprises components for measuring relative position.

Another aspect of the invention relates to a nuclear reactor comprising a position measurement system as previously mentioned.

### BRIEF DESCRIPTION OF THE FIGURES

Further characteristics and advantages of the invention will become apparent from the description thereof given below, by way of indicating and in no way limiting purposes, with reference to the appended figures, among which:

FIG. 1 is a simplified diagram of a pressurised water nuclear reactor vessel;

FIG. 2 represents a movable rod in its fixed housing in which optical fibre probes and target tracks are placed;

FIG. 3 represents an optical fibre probe in detail;

FIG. 4 is a cross-section view of the optical fibre probe;

FIG. 5 represents an assembly of tracks consisting of diffusing and reflecting surfaces;

FIG. 6 represents a pair of surfaces consisting of a reflecting surface and a diffusing surface in detail;

FIG. 7 represents a first embodiment of a system for measuring absolute position of a translational control rod;

FIG. 8 represents a second embodiment of the system for measuring absolute position of a translational control rod;

FIG. 9 represents one embodiment of a system for measuring relative position of a translational control rod.

FIG. 10 is a block diagram representing a method for measuring position of a translationally movable element in a nuclear reactor;

FIG. 11 is a graphical representation of the intensity of an optical signal received by an optical fibre probe as a function of the position of a translationally movable element;

FIG. 12 is a block diagram representing a method for measuring relative position of a translationally movable element of a nuclear reactor.

### DETAILED DESCRIPTION

Unless otherwise specified, a same element appearing in different figures has a single reference.

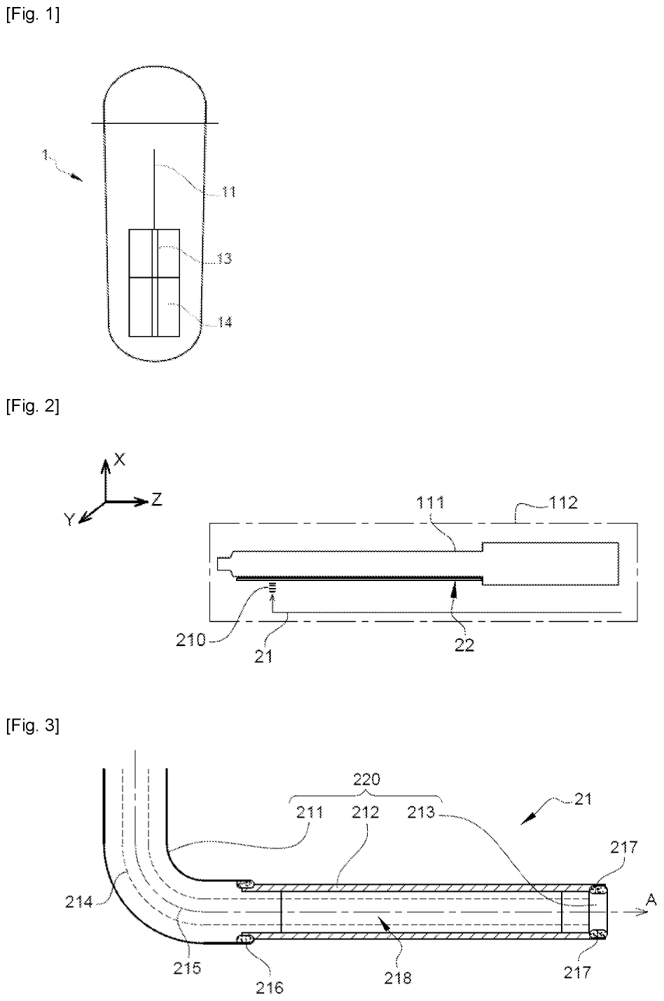

FIG. 1 is a diagram of a pressurised water reactor (PWR) vessel 1, of which an assembly 11 consisting of a translational control rod 111, the position of which is to be measured, in its fixed part 112, an element of the control rod bundle guides 13 and a core element 14 is shown. Water circulating in the vessel is subject to the pressure, temperature and flow conditions of the primary circuit:
Particularly corrosive high-temperature pressurised water environment
Pressure between 120 bar and 180 bar
Temperature between 250° C. and 350° C.
Water flow rate between 2 m/s and 5 m/s
Irradiation (gamma and neutrons) between 2 MGy and 100 MGy

In the following, the environment of the primary circuit will be referred to as the primary medium. Thus, any element introduced into the vessel should be resistant to the aforementioned primary medium.

FIG. 2 shows in greater detail a translational control rod 111, the position of which is sought to be measured, in its fixed part 112, hereinafter referred to as the housing, located in the vessel 1. When it is moved, the translational control rod 111 moves relative to the housing 112 along the axis z, along which it extends. This representation depicts optical fibre probes 21, attached to the housing 112, emitting optical signals 210 towards target tracks 22 integral with the translational control rod 111.

FIG. 3 shows a detailed diagram of an optical fibre probe 21. The probe 21 comprises a protective envelope 220 consisting of a flexible part 211, a rigid part 212 of axis A and a transparent window 213. The flexible part may, for example, be a metal tube, resistant to a primary medium, with a sufficient length to allow it to leave the primary medium and reach a less aggressive medium, via a vessel bushing similar to the vessel bushing described in patent EP 33 17 883. The flexible part 211 is connected through welds, preferably solders 216, to the rigid part 212, which may also be a tube made of one or more metals resistant to a primary medium. A metal making up the rigid and/or flexible parts may be 316L stainless steel, which is a stainless steel not subject to corrosion and compatible with a primary medium water. The inner wall of the rigid part 212 is soldered to the copper, gold or aluminium sheaths of the optical fibres at the surface 218 to prevent said optical fibres from slipping within the rigid part; this soldering is made possible by a metallic coating of the bare fibres and may require, according to the geometry chosen for the fibres and the rigid tube, metal adapting pieces.

The transparent window 213, enabling optical signals to be transmitted, is connected to the rigid part 212 by means of welds, preferably solders 217. The transparent window 213 is sealed and resistant to a primary medium, oxidation and corrosion. The window may be a porthole made of glass, for example sapphire, chosen so that the coefficients of expansion of the transparent window 213 and the rigid part 212 are matched in order to prevent breakage of the solders 217 during temperature transitions of the primary medium. The transparent window 213, the rigid part 212 and the flexible part 211 have substantially the same diameter. Said diameter is typically between 2 and 4 mm.

In this example, the solders 216 from a first end of the rigid part 212 to one end of the flexible part 211 and the solders 217 from a second end of the rigid part to the transparent window 213 ensure sealing of the two ends of the rigid part 212.

The envelope 220 of the probe 21 comprises a plurality of optical fibres, which it protects from aggressions by the primary medium, including an emitter optical fibre 215 and several receiver optical fibres 214. More generally, the envelope 220 may comprise one or more receiver optical fibres 215.

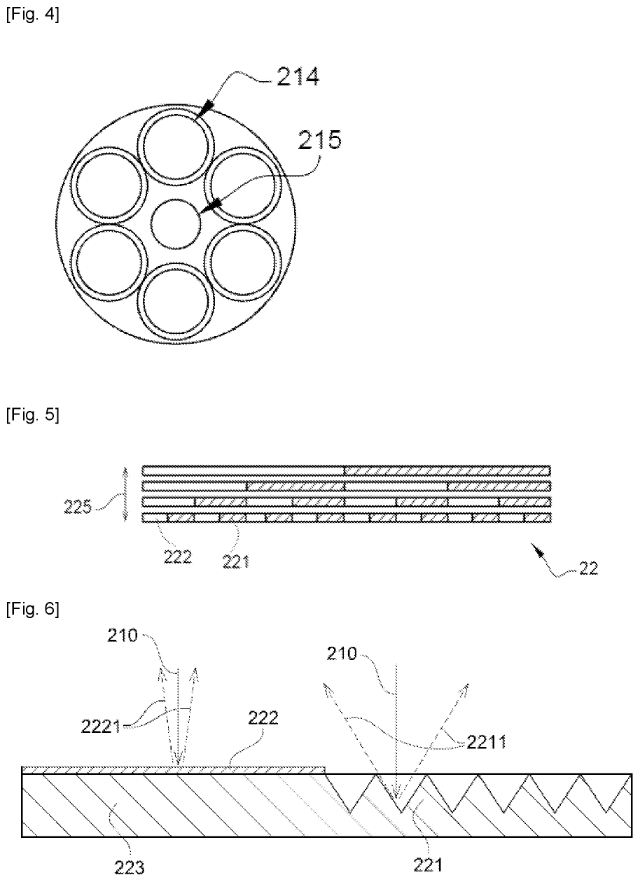

FIG. 4 is a transverse cross-section view of the probe in which there are represented: an emitter optical fibre 215 and a plurality of multimode receiver optical fibres 214 which surround it so as to optimise collection of optical signals received. The optical signals propagating within the fibres can have wavelengths of between 800 and 1200 nm for multimode fibres and between 1000 and 1200 nm for single-mode fibres. The optical fibres may, for example, be designed with a copper sheath and an ultra-pure silica core with a low OH (hydroxyl group) content in order to avoid their darkening under the effect of nuclear radiations at the wavelengths previously mentioned.

Each probe 21 emits optical signals 210 towards a target track 22. FIG. 5 is a representation of four tracks 22, each preferably spaced apart by 3 mm from the other. The tracks are made up of alternating reflecting 222 and diffusing 221 or absorbing surfaces. More generally, a number of tracks N can be chosen to measure 2 N different positions of the translational control rod 111, the measurement accuracy being equal to the stroke of a translational control rod 111 divided by 2 N. In the case of FIG. 5, 24=16 different positions of the translational drive rod 111 can be measured. The stroke of a translational control rod 111 is typically between 2000 mm and 4000 mm, so the measurement accuracy is equal to: 1/2 N of the total displacement distance of the movable part. The length of the tracks 22 is equal to the stroke of the translational control rod 111, and the total width 225 of the 4 tracks is preferably 10 mm.

The tracks 22 are made of materials resistant to the conditions of a primary medium, to oxidation and to corrosion, so that their blackening is minimal. FIG. 6 shows in detail part of a track comprising a reflecting surface 222 and a diffusing surface 221. A primary medium-resistant metal piece 223 designed with materials such as 316 L stainless steel is used to design the reflecting surface 222 and the diffusing surface 221. To obtain a reflecting surface 222, the metal piece 223 is coated with a metal that is not or only slightly sensitive to oxidation, such as hard chrome or gold for example. The diffusing surface 221 results from machining a rough surface on the metal piece 223.

A characteristic of a rough surface is the parameter Ra, which measures distance between the arithmetic mean of the absolute values of the deviations, between the peaks and troughs and the centre line. Ra is preferably 3.6 for diffusing surfaces 221 and 0.2 for reflecting surfaces. In addition, the depth of the diffusing surfaces 221 relative to the reflecting surfaces 222 can be between 2 mm and 5 mm.

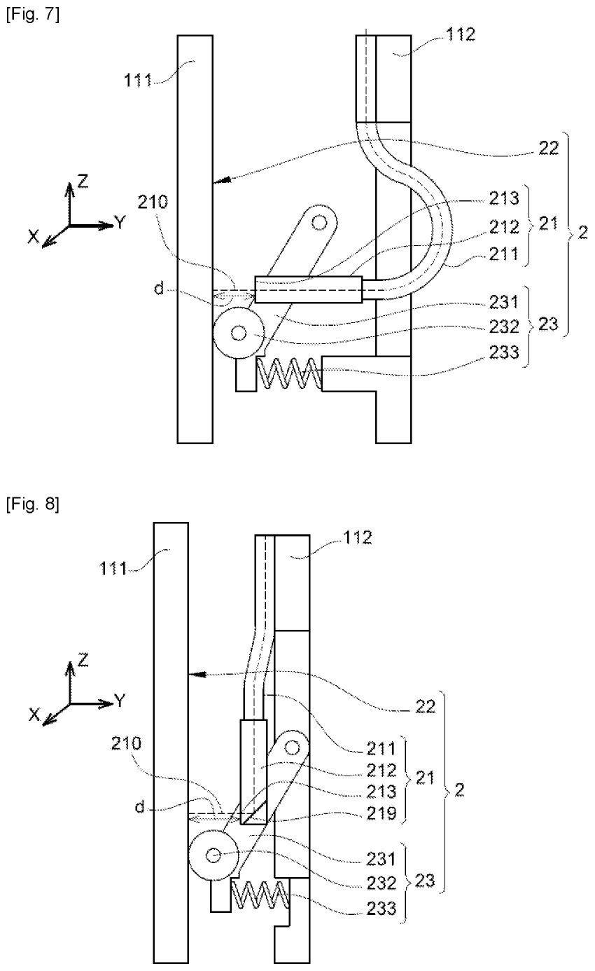

FIG. 7 shows a first embodiment of the system 2 for measuring position of a translational control rod 111. The measurement system 2 comprises a track 22, a corresponding optical fibre probe 21 and a follower system 23 consisting of a hinged arm 231, a roller 232 and a spring 233. The flexible part 211 of the probe is partly integral with the housing 112, and the rigid part 212 is integral with the hinged arm 231. The hinged arm 231 is integral with the roller 232 which is in contact with the track 22 attached to the translational control rod 111. The hinged arm 231 is also integral with the spring 233, attached to the housing 112.

In this embodiment, the rigid part 212 is perpendicular to the translational control rod 111, the optical signals emitted by an emitter optical fibre included in the optical fibre probe 21 encounter only one surface within the probe: the transparent window 213. The optical signals 210 emitted by the probe 21 then pass through the primary medium whose refractive index is sensitive to temperature and can degrade intensity of said optical signals 210. The distance d travelled by the optical signals 210 should therefore be constant and as small as possible, while still allowing the play required for proper translation of the movable part. Typically this distance is in the order of a few mm, between 0.5 and 5 mm for example, in order to avoid loss of intensity of the optical signals 210. However, the operation of CRDMs (Control Rod Drive Mechanism) gives rise to vibrations and mechanical play when moving the translational control rods 111, which can vary the distance d travelled by the optical signals, which is why the follower system 23 has been implemented to keep this distance d constant. The follower system 23 is mechanically controlled by the spring 233, which extends or compresses when the roller 232 is driven by a translational control rod 11 in the event of movement in a direction other than the axis z along which the translational control rod 111 extends. The spring causes the hinged arm 231 to rotate about the axis x, allowing the roller to remain in contact with a track 22.

In FIG. 8, a second embodiment of the invention is set forth. In this embodiment, the probe 21 is parallel to the translational control rod 111 and its envelope 220 comprises a mirror 219 placed at 45° with respect to the axis A of the rigid part 212 of the probe 21. The optical signals emitted by the emitter optical fibre 215 of the probe 21 are first reflected by mirror 219 before being transmitted through the transparent window 213. A mirror is defined as any surface capable of reflecting optical signals. This method is favoured when a low overall size is required, or when the maximum radius of curvature of the flexible part 211 is between 30 and 50 mm, for example, and does not allow the embodiment set forth in FIG. 7 to be made.

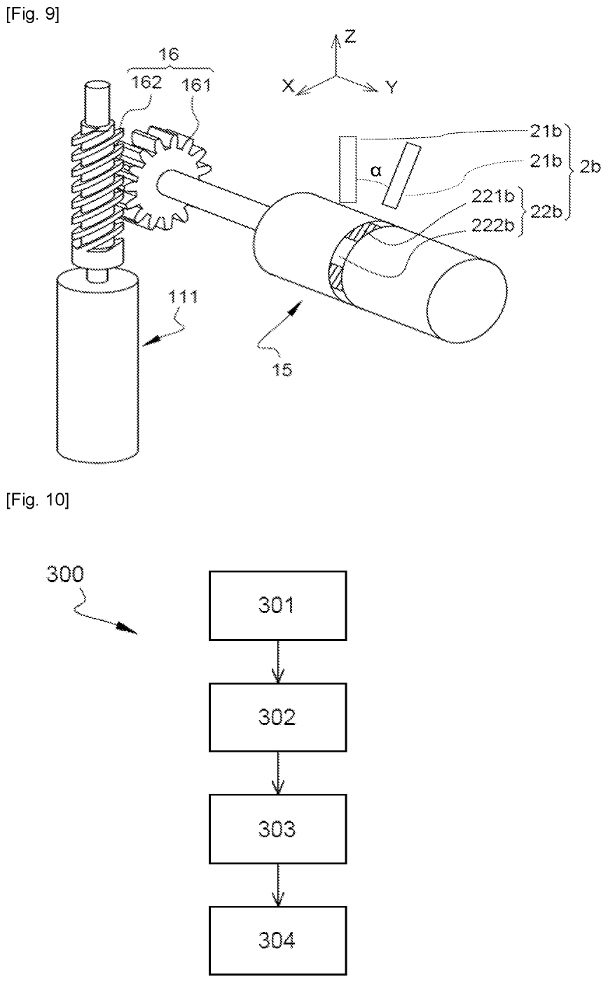

FIG. 9 represents a variant of the invention, in which, in addition to one of the two preceding embodiments, a second relative measurement sub-system 2b, which is complementary to and different from the preceding one, makes it possible to measure relative position of the translationally movable rod 111 by measuring the number of revolutions made by a cylindrical component 15 driven by the translationally movable control rod 111 by means of a screw-nut mechanism 16 and, more precisely, wheel 161 and worm screw 162 with a pitch p, expressed in mm.

The mechanism 16 transforms the movement of the translational control rod 111 into a rotational movement of the cylindrical component 15 with a ratio p expressed in mm/rev. This mechanism 16 is detailed in patent EP 3 329 493 B1. The relative measurement system 2b comprises an auxiliary track 22b surrounding the cylindrical component 15, said auxiliary track 22b consisting of P reflecting surfaces 222b and P diffusing surfaces 221b, P being an integer greater than or equal to 1. System 2b also comprises two auxiliary probes 21b identical to those previously described, facing the auxiliary track 22b, spaced apart by a non-zero angle α lower than 360°/P.

FIG. 10 is a block diagram illustrating the sequence of steps of the measurement method 300 according to the invention. The method is carried out by means of the optical fibre measurement system 2 described in FIGS. 7 and 8 and makes it possible to obtain absolute position of a movable element in the vessel of a nuclear reactor, for example a movable control rod 111.

A first step of the method consists in emitting 301 one or more optical signals respectively by an emitter fibre 215 of one or more probes 21, wherein the wavelengths of the signals can lie between 800 and 1200 nm. The signals are received in a second step 302 by one or more tracks 22, each probe being in front of a track 22 so that each optical signal is received by a single track. If an optical signal is received by a reflecting track 222 and is returned by said reflecting track, then it will be said to be reflected, and if an optical signal is received by a diffusing track and is diffused by said diffusing track 221, then it will be said to be diffused. The so-called reflected 2221 or diffused 2211 signals are then received by the multimode receiver fibres 214 in a third step 303.

The optical signals received by the receiver optical fibres 214 are then processed and converted in a unit (not shown) in a fourth step 304. When a received signal is a reflected signal 2221, then its corresponding code will be 1, and when a received signal is a diffused signal 2211, then its corresponding code will be 0, this type of coding being called binary coding. For a probe, the reflected or diffused nature of an optical signal received by the receiver fibres 214 is determined depending on the value of the intensity of the optical signal received by the receiver fibres 214.

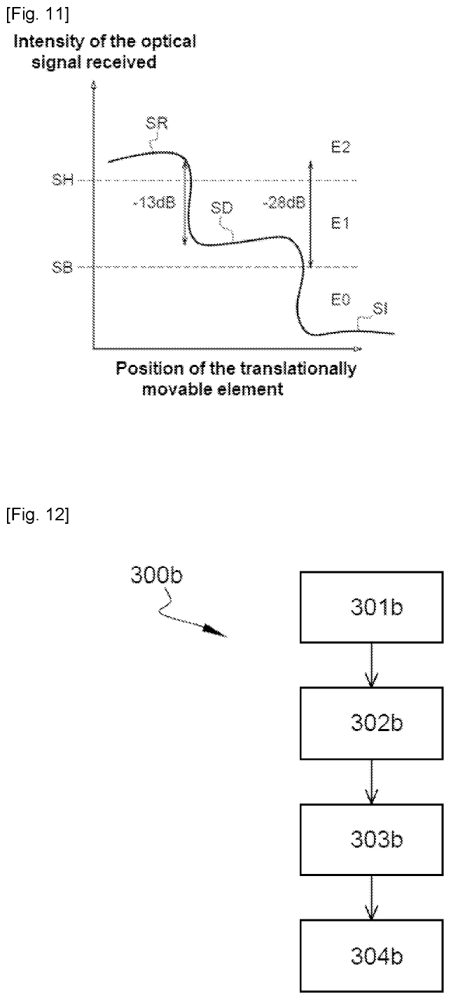

FIG. 11 is a graphical representation of the intensity of an optical signal received by a receiver fibre as a function of the position of the translationally movable element 111. When the intensity of the received optical signal is greater than or equal to a threshold SH, also called the high threshold, then the signal is said to be reflected and has an intensity SR. When the intensity of the received optical signal is greater than or equal to a threshold SB, also called the low threshold, and strictly lower than SH, then the received optical signal is said to be diffused and has an intensity SD. When the signal intensity is strictly lower than the threshold SB, the signal is considered defective and has an intensity SI. The difference in intensity between the intensity SR of a reflected signal 2221 and the intensity SD of a diffused signal 2211 is preferably in the order of 13 dB and the difference in intensity between a reflected signal 2221 and a defective signal is preferably in the order of 28 dB. These values thus make it possible to determine the preferred minimum deviation between the high threshold SH and the low threshold SB: the difference SR-SH being lower than or equal to 13 dB, and the difference SR-SB being equal to 28 dB, it is then deduced that the difference SH-SB is greater than or equal to 15 dB. This type of coding a so-called three-level coding and enables faults and anomalies to be detected: indeed, a limitation to two coding levels (reflected/diffused) would be dangerous because a received signal could wrongly be considered as diffused and any anomaly would not be detected in time.

A defective signal could result from a misalignment between the optical fibre probes 21 and the tracks 22, for example, or from a malfunction of the probes 21, for example.

When the measurement system 2 comprises N optical fibre probes 21 and N tracks 22, the position of the translationally movable control rod 111 will be given in the form of a binary code with N digits each respectively included in the set {0,1}.

FIG. 12 is a block diagram illustrating the sequence of additional steps of the method 300 for obtaining a measurement of relative position of a translationally movable element, for example the translationally movable control rod 111. The method is carried out by means of the optical fibre measurement system 2b previously mentioned.

A first step, among the additional steps of the method, consists in emitting 301b two optical signals respectively by two emitter fibres 215 of two auxiliary probes 21b, spaced apart by an angle α, wherein the wavelengths of the signals can lie between 800 and 1200 nm. The signals are received in a second step 302b by an auxiliary track 22b. If an optical signal is received by a reflecting track 222b and is reflected by said reflecting track, then it will be said to be reflected, and if an optical signal is received by a diffusing track 221b and is diffused by said diffusing track 221 then it will be said to be diffused. The so-called reflected 2221 or diffused 2211 signals are then received by the receiver fibres 214 in a third step 303b.

The optical signals received by the receiver optical fibres 214 are then processed by a unit. The offset by an angle α between the two auxiliary probes 21b makes it possible to determine, by means of the processing unit, the number of times the cylindrical component 15 has rotated by an angle α and to deduce displacement of the translationally movable element 111 by means of the ratio p expressed in mm/rev. The phase shift between the two optical signals received by the receiver fibres 214 makes it possible to determine the direction of rotation of the cylindrical component 16 and therefore the direction of displacement of the translationally movable element 111. The relative measurement of a translationally movable element 111 requires initial calibration. The measurement accuracy of said relative measurement depends on the number P of reflecting surfaces 222b and the number P of diffusing surfaces 221b and the pitch p of the worm screw 162, and is equal to p/P. The pitch p is preferably 20 mm and the number P is preferably between 5 and 10, so the accuracy in measuring position of a translationally movable element 111 is preferably between 2 and 4 mm.

1. A method for measuring position of a translationally movable element of a nuclear reactor, the method comprising:
emitting kN optical signals, k and N being integers greater than or equal to 1, by kN emitter optical fibres included in N probes resistant to a primary medium;
receiving the kN optical signals by N tracks resistant to a primary medium, each track receiving k optical signals, said N tracks consisting of reflecting surfaces and diffusing surfaces;
receiving by mN receiver optical fibres, m being a natural number greater than or equal to k, included in the N probes, the kN optical signals reflected or diffused by the N tracks; and
converting the kN optical signals received by the mN receiver optical fibres into binary code.

2. The method according to claim 1, wherein an accuracy in measuring position of a translationally movable element in the nuclear reactor depends on N and is equal to the length of the tracks divided by 2^{N}.

3. The method according to claim 1, wherein the translationally movable element rotationally drives a cylindrical component, said rotational cylindrical component being surrounded by an auxiliary track consisting of P reflecting surfaces and P diffusing surfaces, P being greater than or equal to 1, said auxiliary track being resistant to a primary medium and receiving optical signals emitted by two auxiliary probes resistant to a primary medium and spaced apart by a non-zero angle, the method further comprising the following additional steps for measuring relative position of the translationally movable element:
emitting two optical signals, by two so called emitter optical fibres included in the two auxiliary probes,
receiving the two optical signals by the track;
receiving, by at least two receiver optical fibres included in the two auxiliary probes, the two optical signals reflected or diffused by the auxiliary track; and
transmitting and interpreting the two optical signals received by the receiver optical fibres by a processing unit.

4. The method according to claim 1, wherein an accuracy in measuring relative position of a translationally movable element in a nuclear reactor depends on a total number of reflecting surfaces and diffusing surfaces and is equal to 2 P.

5. The measurement method according to claim 1, wherein, for one probe, of the N probes and the two auxiliary probes, comprising an emitter optical fibre and at least one receiver optical fibre:
the reflected or diffused nature of an optical signal received by the at least one receiver optical fibre is determined by the intensity of the optical signal received by the at least one receiver optical fibre according to the following steps:
when the intensity of the optical signal received is greater than or equal to a high threshold, the optical signal received by the at least one receiver optical fibre is a so-called reflected optical signal;
when the intensity of the optical signal received is greater than or equal to a low threshold and is strictly lower than the high threshold, the low threshold being strictly lower than the high threshold, the optical signal received by the at least one receiver fibre is a so-called diffused optical signal;
wherein a difference between the intensity of the reflected optical signal and the intensity of the diffused optical signal is equal to 13 dB, and wherein the high threshold is such that a difference between the intensity of the reflected signal and the high threshold is between 0 dB and 13 dB.

6. The measurement method according to claim 1, wherein, for one probe, of the N probes and the two auxiliary probes, comprising an emitter optical fibre and at least one receiver optical fibre:
when the intensity of the optical signal received by the at least one receiver optical fibre is zero or positive and lower than a low threshold, the optical signal is defective.

7. An optical fibre probe for measuring position of a movable element, it wherein the optical fibre probe is able to measure, according to the method described in claim 1, a movable element in a nuclear reactor and comprising:
an emitter optical fibre and a receiver optical fibre;
an envelope for protecting the optical fibres, including:
a sealed flexible part comprising a metal resistant to a primary medium;
a sealed rigid part comprising a metal and a ceramic resistant to a primary medium;
a sealed transparent window resistant to a primary medium.

8. The optical fibre probe according to claim 7, wherein:
a first end of the rigid part is welded to a first end of the flexible part;
a second end of the rigid part is welded to the transparent window.

9. The optical fibre probe according to claim 7, wherein the envelope comprises a mirror tilted by 45° with respect to the axis of the rigid part of the probe.

10. The optical fibre probe according to claim 7, wherein the optical fibres are made of materials resistant to nuclear irradiations.

11. A system for measuring position of a movable element of a nuclear reactor, comprising:
N optical fibre probes;
N tracks consisting of reflecting surfaces and diffusing surfaces resistant to a primary medium, attached to the movable element;
able to implement the method of claim 1.

12. The measurement system according to claim 11, wherein a first track of the N tracks comprises a diffusing surface, a second track of the N tracks comprises a reflecting surface and a diffusing surface and any additional track comprises twice the number of diffusing tracks and reflecting tracks with respect to the preceding track.

13. The measurement system according to claim 11, comprising a mechanical system including:
a roller cooperating with the movable tracks and integral with a hinged arm;
a spring cooperating with the hinged arm and with a fixed support;
and wherein one probe of the N probes is attached to the hinged arm.

14. The measurement system according to claim 11, comprising:
an auxiliary track consisting of P reflecting surfaces and P diffusing surfaces;
two optical fibre probes spaced apart by a non-zero angle.

15. A nuclear reactor, comprising a vessel having a system for measuring position of movable elements according to claim 11.
